(19) United States
(12) Patent Application Publication
(10) Pub. No.: US 2012/0039301 A1
(43) Pub. Date: Feb. 16, 2012

(54) APPARATUS AND METHOD FOR CONTROLLING HARQ AND ARQ IN WIRELESS COMMUNICATION SYSTEM

(75) Inventors: Kyung Jin KIM, Seoul (KR); Sung Kwan KIM, Suwon-si (KR); Yoon Jeong HA, Seongnam-si (KR)

(73) Assignee: SAMSUNG ELECTRONICS CO. LTD., Suwon-si (KR)

(21) Appl. No.: 13/208,696

(22) Filed: Aug. 12, 2011

(30) Foreign Application Priority Data
Aug. 16, 2010 (KR) 10-2010-0078634
Aug. 11, 2011 (KR) 10-2011-0079978

(51) Int. Cl. H04W 72/04; H04W 36/00

(52) U.S. Cl. 370/331; 370/329

(57) ABSTRACT

A method for controlling a Hybrid Automatic Repeat Request (HARQ) of a mobile communication system is provided. The method includes establishing a default Best Effort (BE) connection, transmitting, when a Dynamic Service Addition (DSA) is request for a new service, an Advance Air Interface_Registration-Request (AAI_DSA-REQ) message including HARQ channel mapping information from a base station to a mobile station, and transmitting, when the AAI_DSA-REQ message is received from the base station, an Advance Air Interface_Dynamic Service Addition-Response (AAI_DSA-RSP) message from the mobile station to the base station in order to establish a HARQ channel based on the HARQ channel mapping information.

### PRIORITY

This application claims the benefit under 35 U.S.C. §119(a) of a Korean patent application filed on Aug. 16, 2010 in the Korean Intellectual Property Office and assigned Serial No. 10-2010-0078634 and Aug. 11, 2011 in the Korean Intellectual Property Office and assigned Serial No. 10-2011-0079978, the entire disclosure of which is hereby incorporated by reference.

### BACKGROUND OF THE INVENTION

1. Field of the Invention

The present invention relates to a Hybrid Automatic Repeat Request (HARQ) and Automatic Repeat Request (ARQ) control apparatus and method for a mobile communication system. More particularly, the present invention relates to an apparatus and method for adding or changing HARQ and ARQ parameters.

2. Description of the Related Art

In a network implemented according to the Institute of Electrical and Electronics Engineers (IEEE) 802.16m standard, a base station establishes an initial default Best Effort (BE) connection via a Registration (REG) process or establishes a unicast connection via a Dynamic Service Addition (DSA) process for supporting a Quality of Service (QoS) of a mobile station by exchanging QoS parameters. Afterwards, the mobile station or the base station can change the QoS parameters through a Dynamic Service Change (DSC) process, such that the services are provided continuously with the changed QoS parameter after the DSC process.

In the 802.16m standard, the mobile station and the base station establish uplink/downlink BE connections, while having the QoS parameters predefined in the registration procedure using Advance Air Interface_Registration-Request/Response (AAI_REG-REQ/RSP) messages. When establishing the default BE connection, Dynamic Host Configuration Protocol (DHCP) messages are exchanged for assigning an Internet Protocol (IP) address via in-band signaling. However, the 802.16m standard specifies that the default BE connection supports HARQ but not ARQ. HARQ is advantageous because it increases a reception rate by obtaining a time diversity gain with a retransmission mechanism and a coding gain with a combination of a plurality of received packets. However, the wireless channel used for the BE connection may experience deep fading, and in such a case, all retransmission attempts fail during the short period of deep fading, resulting in no time diversity gain. In the 802.16m standard, the Transmission Time Interval (TTI) is shortened as compared to the 802.16e standards, such that the time diversity gain obtained by using a HARQ retransmission scheme is less likely to occur. As a result, use of the HARQ retransmission scheme may cause problems with respect to reliable transmission of signaling traffic, such as DHCP. Thus, there is a need for supporting ARQ at a higher layer, such as a Media Access Control (MAC) layer as a retransmission mechanism.

Also, in terms of HARQ parameters, the IEEE 802.16m/D7 standard does not specify DSA and DSC messages, and thus, definitions of the DSA and the DSC messages are ambiguous. Since the HARQ retransmission scheme is performed by a base station, the HARQ parameters can be defined differently depending on a manufacturer or base station type or model. Among the HARQ-related parameters, the number of HARQ Channels, or ARQ Channel Identifiers (ACIDs), can be changed according to a service type, a base station capacity, a service provider's policy, or other similar factors. Thus, if the base station is not allowed to set or change a corresponding HARQ-related parameter value using the DSA or DSC messages, then a network operating in a multi-vendor type scenario may have interoperability problems between different vendor facilities. Accordingly, the HARQ-related parameters to be used in a DSA messaging process are negotiated and, when control is handed over to another base station, it should be guaranteed that the target Base Station (BS) supports all of the HARQ parameters of the serving BS. In a case where some or all of the HARQ parameters cannot be changed in the target BS via a DSC messaging process, as in the 802.16m standard of the related art, service quality and continuity is not guaranteed during a handover between different base stations.

Similarly in terms of ARQ parameters, the IEEE 802.16m/D7 standard defines only DSA but not DSC. Due to such a constraint, the ARQ operates with fixed ARQ parameters that are determined in a network, even when the air environment varies, without reflecting the variation, and thus resulting in traffic loss.

### SUMMARY OF THE INVENTION

Aspects of the present invention are to address at least the above-mentioned problems and/or disadvantages and to provide at least the advantages described below. Accordingly, an aspect of the present invention modifies definitions of Dynamic Service Addition (DSA) and Dynamic Service Change (DSC) of 802.16m in order to add authority of changing Hybrid Automatic Repeat Request (HARQ) and Automatic Repeat Request (ARQ) parameters, thereby enabling dynamic management that is adaptive to network conditions and improves Quality of Service (QoS).

An exemplary embodiment of the present invention supports HARQ channel mapping negotiation function through DSA and DSC processes. That is, a method according to an embodiment of the present invention is capable of adding a HARQ parameter such as a HARQ channel mapping to AAI_DSA-REQ and AAI_DSA-RSP messages, determining the HARQ channel mapping in a DSA process, changing the HARQ parameter such as HARQ channel mapping in AAI_DSC-REQ and AAI_DSC-RSP, and changing the HARQ channel mapping in the DSC process.

Another exemplary embodiment of the present invention supports ARQ enable and ARQ parameter negotiation functions in the DSC process. That is, the methods according to exemplary embodiments of the present invention are capable of changing ARQ parameters of the AAI_DSC-REQ and AAI_DSC-RSP messages, changing ARQ on/off status in the DSC process, and changing ARQ parameters in the DSC process.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram illustrating an exemplary situation of Hybrid Automatic Repeat Request (HARQ) channel mapping for adding a new service through a Dynamic Service Addition (DSA) according to an exemplary embodiment of the present invention;

FIG. 2 is a signaling diagram illustrating a configuration procedure of the HARQ channel mapping for Voice over Internet Protocol (VoIP) through the DSA in the situation of FIG. 1 according to an exemplary embodiment of the present invention;

FIG. 3 is a diagram illustrating an exemplary situation of changing HARQ channel mapping through DSC according to an exemplary embodiment of the present invention;

FIG. 4 is a signaling diagram illustrating a procedure of changing the HARQ channel mapping through the DSC in the exemplary situation of FIG. 3 according to an exemplary embodiment of the present invention;

FIG. 5 is a signaling diagram illustrating a procedure for turning on ARQ over the Best Effort (BE) connection through DSC according to an exemplary embodiment of the present invention;

FIG. 6 is a diagram illustrating an exemplary situation of changing ARQ parameters used currently according to an exemplary embodiment of the present invention;

FIG. 7 is a signaling diagram illustrating a procedure for changing cell-specific ARQ settings in the exemplary situation of FIG. 6 according to an exemplary embodiment of the present invention;

FIG. 8 is diagram illustrating an exemplary situation of changing ARQ parameters due to the handover between base stations operating with different ARQ parameters according to an exemplary embodiment of the present invention; and

FIG. 9 is a flowchart illustrating a procedure of changing ARQ parameters after completion of handover in the exemplary situation of FIG. 8 according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

According to an exemplary embodiment of the present invention, a method for controlling a Hybrid Automatic Repeat Request (HARQ) of a mobile communication system gives an authorization that is capable of negotiating HARQ parameters and an Automatic Repeat Request (ARQ) enable/disable in Advanced Air Interface_Dynamic Service Addition-Request/Response (AAI_DSA-REQ/RSP) and Advanced Air Interface_Dynamic Service Change-Request/Response (AAI_DSC-REQ/RSP) messages defined in the 802.16m standard and negotiating ARQ-related Quality of Service (QoS) parameters when ARQ is enabled. That is, an exemplary embodiment of the present invention proposes a method for supporting a HARQ channel mapping negotiation function in a Dynamic Service Acquisition (DSA) and ARQ enable and ARQ parameter negotiation functions in a Dynamic Service Change (DSC).

In a case where the HARQ channel mapping negotiation function is supported in DSA, it is possible to add the HARQ parameter such as HARQ channel mapping to an AAI_DSA-REQ and an AAI_DSA-RSP, determine HARQ channel mapping in a DSA process, change HARQ parameters, such as HARQ channel mapping of an AAI_DSC-REQ and an AAI_DSC-RSP, and change HARQ channel mapping in a DSC process. In a case where ARQ enable and ARQ parameter negotiation functions are supported in DSC, it is possible to change the ARQ parameter in an AAI_DSC-REQ and an AAI_DSC-RSP and change ARQ on/off in a DSC process.

For this purpose, in an exemplary embodiment of the present invention, new attributes of the AAI_DSA-REQ/RSP and AAI_DSC-REQ/RSP messages are added as shown in Tables 1 and 2. Tables 1 and 2 show the parameters to be added in an exemplary embodiment of the present invention. In compliance with the 802.16e standard, the HARQ context is defined with HARQ enable, HARQ mapping, and Packet Data Unit (PDU) (Sub-Network) (SN) Reordering Type for HARQ. Since HARQ is mandatory in 802.16m, HARQ enable is excluded in 802.16m HARQ parameters because HARQ is not a configurable option, and a PDU SN combined with SN in 802.16m is also omitted. In Tables 1 and 2, the HARQ channel mapping attribute has a size of 16 bits. This means that HARQ channel indices corresponding to 16 ARQ Channel Identifiers (ACIDs) can be expressed using the 16 bits, and having a certain bit is set to 1 indicates that the corresponding ACID is used. Here, bit 0-bit 15 correspond to ACID 0-ACID 15 and thus the HARQ channel mapping can be made of up to 16 ACIDs. Although the HARQ channel mapping attribute is expressed by 16 bits in the present exemplary embodiment of the present invention, the present invention is not limited thereto, and the HARQ channel mapping attribute may be expressed by any suitable number of bits, for example, it can be expressed by 4*16 or 8*16 bits.

TABLE 1
AAI_DSA-REQ/RSP

| M/ | | | | |
|---|---|---|---|---|
| O | Attribute | Size | Value/Note | Condition |
| M | Frequency Identifier | 4 | The change count of this | N/A |
| | (FID) Change Count | | transaction assigned by | |
| | | | the sender. If new | |
| | | | transaction is started, | |
| | | | FID Change Count is | |
| | | | incremented by one | |
| | | | (modulo 16) by the | |
| | | | sender. | |
| | . . . | | . . . | |
| 0 | HARQ Channel | 16 | HARQ channel index. | when this |
| | Mapping | | Each bit indicates | attribute is |
| | | | whether ACID is used, | not present, |
| | | | and if corresponding bit | it means |
| | | | is set to 1, this means | using all |
| | | | using corresponding | HARQ |
| | | | ACID. Least Significant | channels. |
| | | | Bit (LSB) Bit#0 | |
| | | | indicates ACID 0. | |

TABLE 2
AAI_DSC-REQ/RSP

| M/O | Attribute | Size | Value/Note | Condition |
|---|---|---|---|---|
| M | FID Change Count | 4 | The change count of this | N/A |
| | | | transaction assigned by | |
| | | | the sender. If new | |
| | | | transaction is started, | |
| | | | FID Change Count is | |
| | | | incremented by one | |
| | | | (modulo 16) by the | |
| | | | sender. | |
| | . . . | | . . . | |
| 0 | HARQ Channel Mapping | 16 | HARQ channel index. | when this |
| | | | Each bit indicate whether | Attribute is |
| | | | ACID is used, and if | not present, it |
| | | | corresponding bit is set | means using |
| | | | to 1, this means using | all HARQ |
| | | | corresponding ACID. | channels |
| | | | LSB Bit#0 indicates | |
| | | | ACID 0. | |
| 0 | ARQ parameters | var. | | |
| 0 | A) ARQ Enable | 1 | 0 = ARQ Not Requested | |
| | | | 1 = ARQ Requested | |
| 0 | B) | 16 | the maximum number of | |
| | ARQ_WINDOW_SIZE | | ARQ blocks with | |
| | | | consecutive SN in the | |
| | | | sliding window of ARQ | |
| | | | blocks | |
| | | | >0 | |
| | | | <=(ARQ_BSN_MODULUS/ | |
| | | | 2) | |
| 0 | C) | 16 | 0 = Infinite 1-6553500 “” | |
| | ARQ_BLOCK_LIFETIME | | μs(100 “ ” μs | |
| | | | granularity) | |
| 0 | D) | 16 | 0 = Infinite 1-6553500 “ ” | |
| | ARQ_SYNC_LOSS_TIMEOUT | | μs(100 “ ” μs | |
| | | | granularity) | |
| 0 | E) | 16 | the time interval the | |
| | ARQ_RX_PURGE_TIMEOUT | | receiver shall wait after | |
| | | | successful reception of a | |
| | | | block that does not result | |
| | | | in advancement of | |
| | | | ARQ_RX_WINDOW_START, | |
| | | | before advancing | |
| | | | ARQ_RX_WINDOW_START | |
| | | | 0 = Infinite 1-6553500 “” | |
| | | | μs(100 “ ” μs | |
| | | | granularity) | |
| 0 | F) | 3 | ARQ sub-block length | |
| | ARQ_SUB_BLOCK_SIZE | | when ARQ block is | |
| | | | fragmented into ARQ | |
| | | | sub-blocks prior to | |
| | | | retransmission with | |
| | | | rearrangement | |
| | | | Bit 0-2: encoding for | |
| | | | selected block size (P), | |
| | | | where the selected block | |
| | | | size is equal to 2\hat{ }(P + 3), | |
| | | | 0 <= P <= 7. ARQ sub- | |
| | | | block size is byte unit | |
| 0 | G) | 16 | Time duration for which | |
| | ARQ_ERROR_DETECTION_TIMEOUT | | the receiver shall wait | |
| | | | before declaring an ARQ | |
| | | | block as being in error. | |
| 0 | H) | 16 | the time duration for | |
| | ARQ_FEEDBACK_POLL_RETRY_TIMEOUT | | which transmitter shall | |
| | | | wait an ARQ feedback | |
| | | | from receiver after an | |
| | | | ARQ feedback poll | |

In the following description, a method to configure and change HARQ channel mapping is described first, and then a method to change ARQ support and parameters is described.

First of all, a description is made of the HARQ channel mapping for adding and changing services such as the DSC and the DSA. The below exemplary embodiment is given where the HARQ channel mapping is changed through a DSC to add and change a HARQ channel mapping for Voice over Internet Protocol (VoIP). Here, the service change can occur when the serving base station is changed or the VoIP connection is changed (i.e. when the VoIP connection transitions from an on state to an off state or vice versa). The serving base station change can occur in a handover process and in an idle mode exit, such as a Quick Connection Setup (QCS), in which the mobile station transitions from an idle mode to an active mode. In the following exemplary embodiment, a description is made under the assumption that the service change occurs by handover.

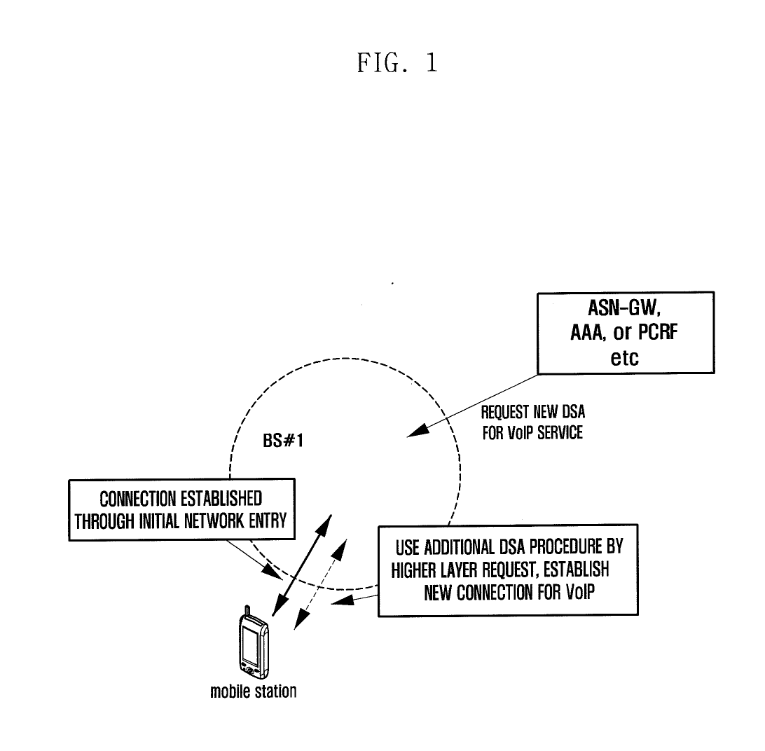

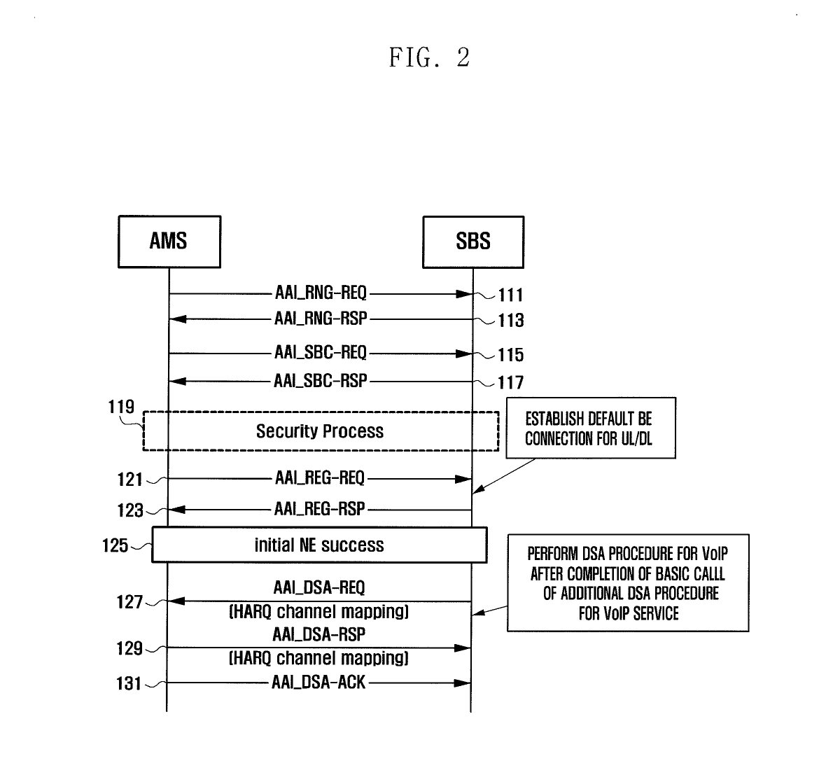

FIG. 1 is a diagram illustrating an exemplary situation of HARQ channel mapping for adding a new service through DSA according to an exemplary embodiment of the present invention. And, FIG. 2 is a signaling diagram illustrating a configuration procedure of the HARQ channel mapping for VoIP through the DSA in the situation of FIG. 1 according to an exemplary embodiment of the present invention.

Referring to FIG. 1, a mobile station and a base station BS#1 establish a call via an initial Network Entry (NE). If an additional Dynamic Service Addition (DSA), such as a VoIP service which is a higher layer request, is requested in such a state, the base station BS#1 establishes a new connection with the mobile station in response to the higher layer request.

Referring to FIG. 2, an Advanced Mobile Station (AMS) and a Serving Base Station (SBS) perform network entry procedure in steps 111 and 113. In the network entry procedure, the AMS and the SBS exchange Advance Air Interface_Registration-Request (AAI_RNG-REQ) and Advance Air Interface_Registration-Response (AAI_RNG-RSP) messages in steps 111 and 113, Advance Air Interface_Session Border Control-Request (AAI_SBC-REQ) and Advance Air Interface_Session Border Control-Response (AAI_SBC-RSP) messages respectively in steps 115 and 117, and Advance Air Interface_Registration-Request (AAI_REG-REQ) and Advance Air Interface_Registration-Response (AAI_REG-RSP) messages respectively in step 121 and 123. Alternatively, the AMS and the SBS may execute a security process at step 119. Through the network entry procedure illustrated in FIG. 2, the AMS and the SBS successfully complete the initial NE at step 125, which means that a default Best Effort (BE) connection is established for Uplink/Downlink (UL/DL) transmission.

In such a state, the AMS and the SBS can add a new service through a DSA. In an exemplary embodiment of the present invention, HARQ channel mapping is configured to guarantee the new service added through the DSA. If a new service is requested, the SBS sends the AMS an AAI_DSA-REQ message to configure the HARQ channel mapping for adding the new service at step 127, and the AMS performs an HARQ channel mapping configuration process and sends the SBS an AAI_DAS-RSP message as reply at step 129. Upon receipt of the reply at step 129, the SBS sends the AMS an AAI_DAS-ACK message at step 131 and ends the procedure.

The DSA-based HARQ mapping configuration procedure is described below in more detail with an exemplary case where the newly requested service is a VoIP service. As shown in FIG. 1, it is assumed that the mobile station supporting VoIP is in compliance with the 802.16m standard and establishes a call through the NE procedure with the base station. In this case, if the NE has completed, the connection setup is established based on the QoS parameter predefined through a Registration (REG) procedure having a default BE service type. Afterward, an additional DSA procedure is performed with an Unsolicited Grant Service (UGS) or an Extended Real-Time Poling Service (ertPS) scheduling type for the VoIP service so as to establish a traffic path. The VoIP service has a feature in which a service quality is guaranteed.

In a case having a large amount of traffic of all the types of services and HARQ retransmissions, a limited amount of ACIDs can be exhausted. That is, if the traffic processing is concentrated on a specific or several unspecific service flows, all the ACIDs are used such that there is no available ACID for processing the traffic of the VoIP service. In this case, the VoIP service is not guaranteed. In order to address this problem, the present exemplary embodiment of the present invention performs negotiation for HARQ channel mapping items defined in Table 1 through a DSA after the completion of NE, as shown in FIG. 2. At this time, some ACIDs are reserved for a specific service type. In the present exemplary embodiment, it is assumed that the HARQ channel mapping Type Length Value (TLV) exchanged with the mobile station is set as indicated by setting bits for reducing air resource loss, such that LSB BIT#0 is ACID 0, and Most Significant Bit (MSB) BIT#15 is ACID 16. However, the present invention is not limited thereto, and the ACID can be set in a variety of suitable ways. For example, such as the ACID can be set in units of 4 bits or 8 bits. If the HARQ Channel mapping attribute is set to 0b0000000000000111, this means ACID 0, 1, and 2 are used for corresponding service flows. If this attribute is absent or all bits are set to 1, this means that all the ACIDs are used.

If the VoIP connection setup is triggered by the mobile station, the AMS sends the AAI_DSC-REQ to the SBS and, in this case, the procedure is performed in the order as shown in FIG. 2 except that the DSA messages are transmitted in opposite directions than shown in FIG. 2.

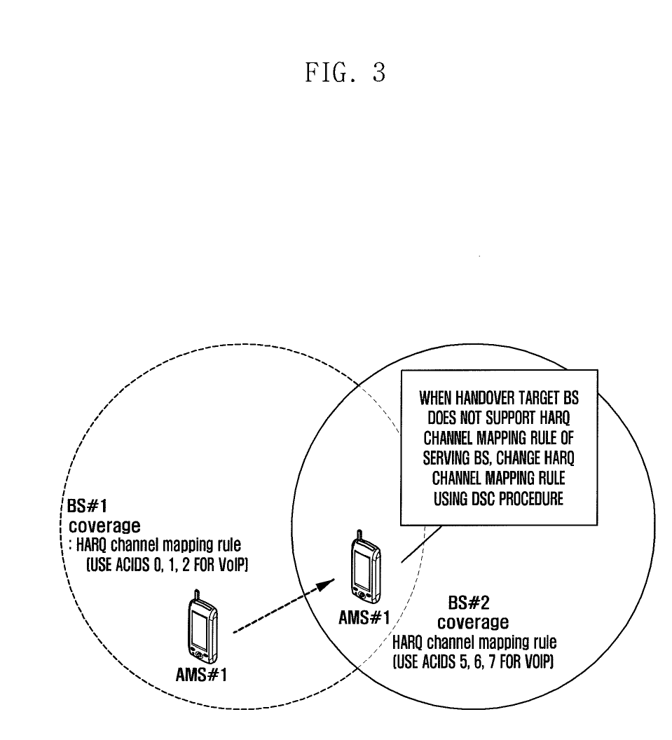

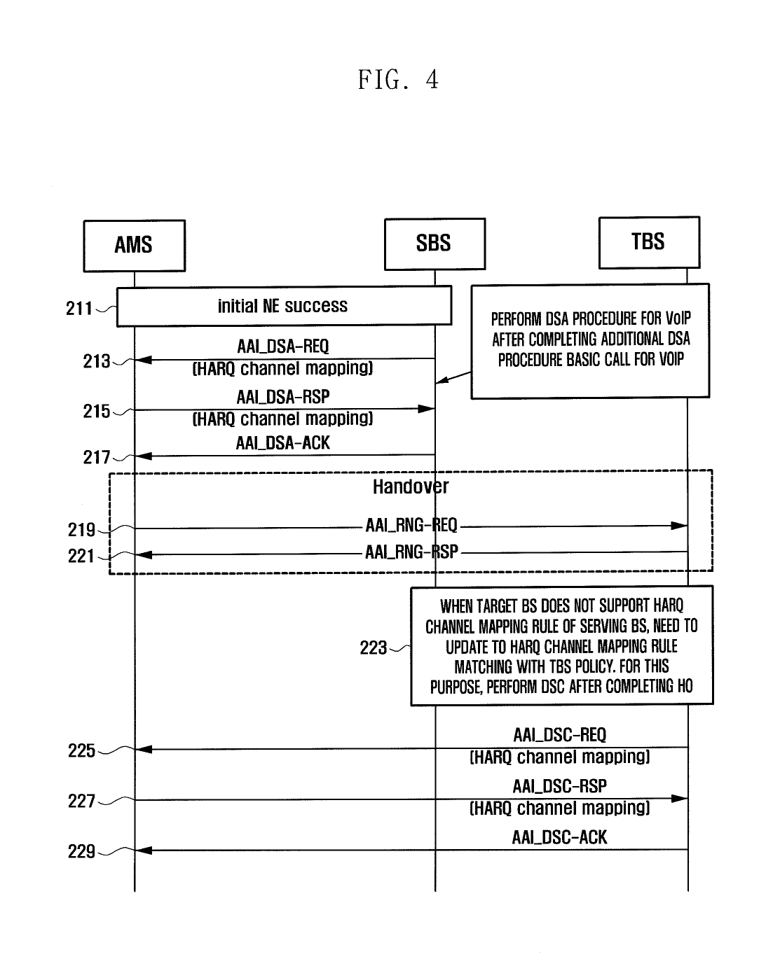

FIG. 3 is a diagram illustrating an exemplary situation of changing a HARQ channel mapping through a DSC according to an exemplary embodiment of the present invention, and FIG. 4 is a signaling diagram illustrating a procedure of changing the HARQ channel mapping through the DSC in the exemplary situation of FIG. 3 according to an exemplary embodiment of the present invention. As aforementioned, the service change can occur due to a change of the base station or a change of the VoIP connection (from an on state to an off state or vice versa), and the change of the base station can occur due to a handover or an idle-to-active mode state transition of the mobile station. In the following, the description is made under the assumption of a service change caused by the handover of the mobile station.

Referring to FIG. 3, after completion of a handover, the HARQ channel mapping between a target base station and the mobile station should be changed. That is, an Advanced Mobile Station (AMS) AMS#1 uses a HARQ channel mapping rule (here, it is assumed that ACIDs 0, 1, and 2 are used for VoIP services) of Serving Base Station (SBS) BS#1 in the service coverage of the BS#1. Afterward, if the AMS#1 moves into the service area of a Target Base Station (TBS) BS#2 through the handover procedure, it is necessary to change the rule for the HARQ channel mapping rule of the BS#2 (here, it is assumed that ACIDs 5, 6, and 7 are used for VoIP). That is, when the handover TBS BS#2 does not support the channel mapping rule of the SBS BS#1, the AMS#1 and the TBS BS#2 perform the DSC procedure to change the rule for the HARQ channel mapping rule supported by the BS#2.

Referring to FIG. 4, in the channel mapping change procedure, the AMS and the SBS perform an initial NE procedure successfully such that the default BE connection is established for UL/DL at step 211. The initial NE procedure can be performed in the same manner as steps 111 to 123 as shown in FIG. 2. If a new service is requested in such a state, the AMS and SBS perform steps 213 to 217. Here, the new service can be the VoIP service, and the DSA procedure is performed for adding the VoIP service after the basic call is terminated. At this time, in order to guarantee the VoIP service, the HARQ channel mapping is configured as previously described with reference to FIG. 2. In this state, if the AMS moves into the service area of the TBS, the AMS and the TBS exchange AAI_RNG-REQ/RSP messages to perform the handover procedure at steps 219 and 221. However, aspects of the invention are not limited thereto and the handover can occur right after the execution of step 211. That is, the handover can be initiated before the configuration of HARQ channel mapping through DSA, or in other words, the handover of the steps 219 and 221 can occur before step 213.

After the completion of the handover, if the TBS does not support the HARQ channel mapping rule of the SBS, the TBS changes the rule for its own HARQ channel mapping rule. In this case, the TBS performs a DSC procedure at step 223 after the completion of the handover and sends the AMS the AAI_DSC-REQ message including the HARQ channel mapping information to be changed at step 225, and the AMS sends the TBS the AAI_DSC-ACK message in reply at step 227. Upon receipt of the AAI_DSC-RSP message, the TBS sends the AMS the AAI_DSC-ACK message at step 229 and terminates the HARQ channel mapping change procedure based on the DSC.

As aforementioned, the HARQ channel mapping rule can be changed according to a base station's capabilities or a manufacturer's policy. Accordingly when the service change occurs due to the handover of the mobile station, it is not guaranteed that the HARQ channel mapping rule of the SBS is supported by the TBS. In a case where the HARQ channel mapping rule is not changed appropriately for the target BS, normal communication is not possible, and the traffic throughput drops. In order to overcome this problem, the HARQ channel mapping rule is changed to match with the respective base station through the procedure of FIG. 4 using the DSC messages defined in Table 2.

Next, a description is made of an ARQ support and parameter change method. In a case where the mobile station or the base station does not support a Host Configuration function for assigning an Internet Protocol (IP) address through a REG procedure, the mobile and base stations exchange DHCP messages for IP address assignment through the predefined default BE connection by in-band signaling. The signaling requires reliable communication such that it is preferred to apply both the HARQ and ARQ. However, the default BE connection configured with the AAI_REG-REQ/RSP messages is defined with ARQ off in the current 802.16m and WiMAX standards. In order to overcome the problem caused by this configuration, it is preferred to turn on the ARQ through the default BE connection by using the DSC procedure after the basic call is established. At this time, it is required that all the related ARQ parameters are transmitted as well as an ARQ enable field.

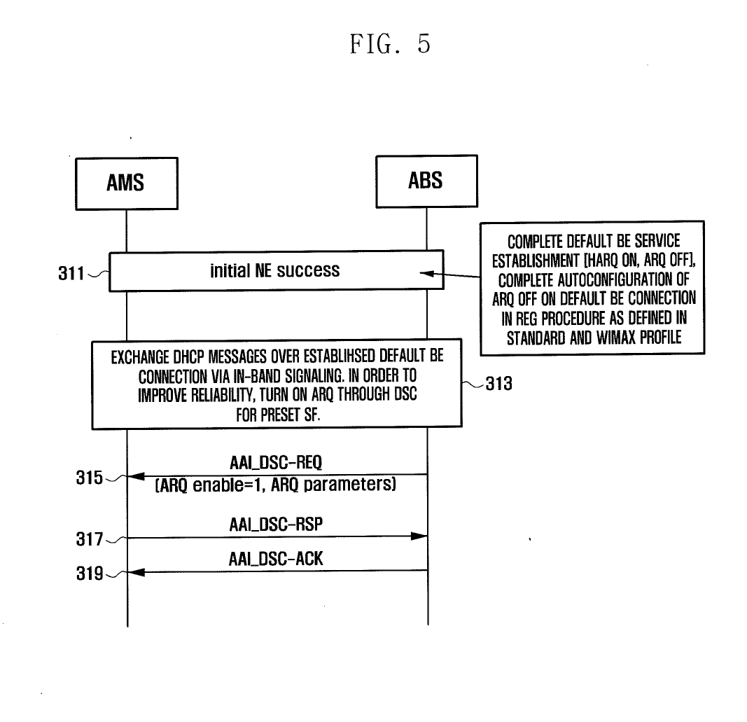

FIG. 5 is a signaling diagram illustrating a procedure for turning on ARQ over the BE connection through DSC messaging according to an exemplary embodiment of the present invention.

Referring to FIG. 5, the AMS and the ABS succeed in an initial NE procedure so as to complete the default BE service configuration at step 311. At this time, the HARQ is on, and the ARQ is off. This is because the ARQ being off is configured automatically in the default BE connection established in compliance with the 802.16m standard and WiMAX standards. Over the default BE connection established as described above, the AMS and ABS exchange DHCP messages via in-band signaling. According to the present exemplary embodiment of the present invention, in order to improve reliability of the in-band signaling message transmission, the AMS and ABS start the procedure to turn on ARQ through the DSC messaging using Table 2 with a preset Service Field (SF) at step 313. For this purpose, the ABS generates an AAI_DSC-REQ message including ARQ enable=1 and ARQ parameters among the AAI_DSC-REQ/RSP message information of Table 2 and sends the AAI_DSC-REQ message to the AMS at step 315. The AMS sends an AAI_DSC-RSP message to the ABS in response to the AAI_DSC-REQ at step 317, and the ABS sends the AMS the AAI_DSC-ACK message at step 319 such that the ARQ turn-on procedure is terminated.

When the mobile station that has established the connection setup in a strong electric field having a good signal strength moves to an area of weak electric field having a poor signal strength, it is preferred to operate ARQ matching with the electric field condition, or signal strength conditions that are at an edge of a cell of the wireless network. For example, in a case of the mobile station, or User Equipment (UE), having a default BE connection, the default setting of the ARQ is off such that there is no issue in the strong electric field. When the mobile station moves to the area of the weak electric field, however, the electric field condition does not get better, and it is preferred to apply ARQ in order to improve traffic performance. Similarly, when the mobile station having the ARQ on state in the weak electric field moves to an area of having the strong electric field, it is preferred to improve the traffic performance by turning off ARQ or applying ARQ parameters in consideration of the channel condition of the strong electric field.

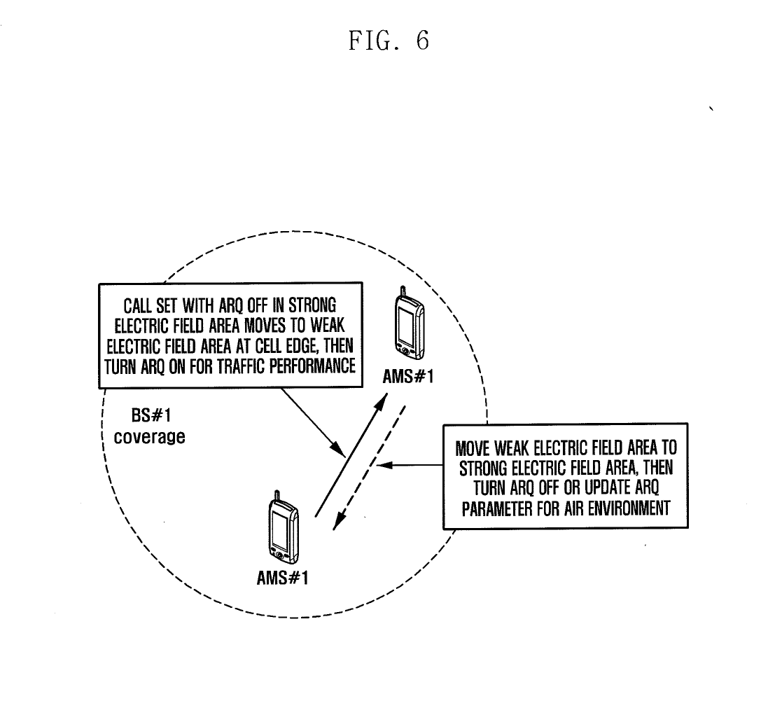

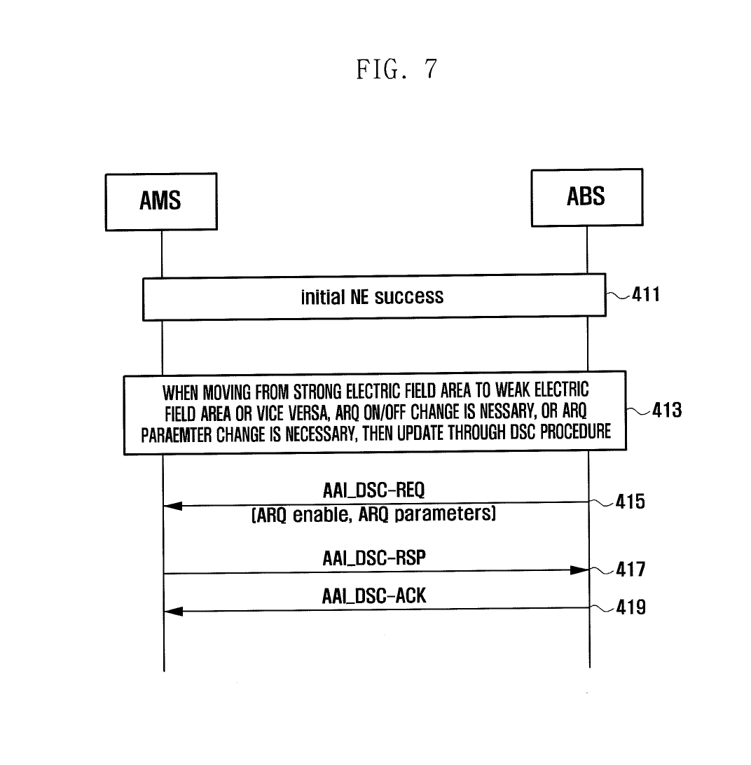

FIG. 6 is a diagram illustrating an exemplary situation of changing ARQ parameters used currently according to an exemplary embodiment of the present invention, and FIG. 7 is a signaling diagram illustrating a procedure for changing cell-specific ARQ settings in the exemplary situation of FIG. 6 according to an exemplary embodiment of the present invention.

Referring to FIG. 6, when an AMS#1 operating on a call connection of which ARQ is off in the strong electric field area within the service coverage of the BS#1 moves to the weak electric field area of an edge of a cell, the ARQ is turned on in order to improve traffic performance. After the ARQ supportability is changed to an on state, if the AMS#1 moves from the weak electric field area to a strong electric field area, the ARQ state is changed to the off state or ARQ parameter matching is executed with the radio environment.

Referring to FIGS. 6 and 7, the AMS succeeds at network entry so as to be connected at step 411. Accordingly, step 411 can be the initial NE success state or a state after a new service is added or a service is changed through DSA/DSC messaging.

In this state, if the mobile station moves from the strong electric field area to the weak electric field area or from the weak electric field area to the strong electric field area such that an ARQ on/off change or an ARQ parameter change is required, the ABS sends the AMS the AAI_DSC-REQ message including an ARQ enable change and ARQ parameters among the AAI_DSC-REQ/RSP message information of Table 2 at step 415. In response to the AAI_DSC-REQ message, the AMS sends the ABS the AAI_DSC-RSP message at step 417, and the ABS sends the AMS the AAI_DSC-ACK message at step 419.

According to another embodiment of the present invention, in a case where the AMS moves from the strong electric field area to the weak electric field area, the ABS sends the AMS the AAI_DSC-REQ message including the information for turning on the ARQ (ARQ enable=1) and ARQ parameters to be changed at step 415. In a case where the AMS moves from the weak electric field area to the storing electric field area, the ABS sends the AMS the AAI_DSC-REQ message including the information for turning off the ARQ (ARQ enable=0) and/or ARQ parameters to be changed in adaptation to the radio environment at step 415.

Although FIG. 7 depicts the procedure for the ABS generating and transmitting the AAI_DSC-REQ message, the present invention is not limited thereto, and the AAI_DSC-REQ can be transmitted from the AMS to the ABS when the DSC is triggered by the AMS, and in this case the DSC messages are transmitted in opposite directions in FIG. 7.

Since ARQ is a base station capability too, specific ARQ parameters of the base station can vary depending on the base station's capabilities or the manufacturer's policy. Accordingly, the ARQ parameters of the serving BS may not be supported by the target BS.

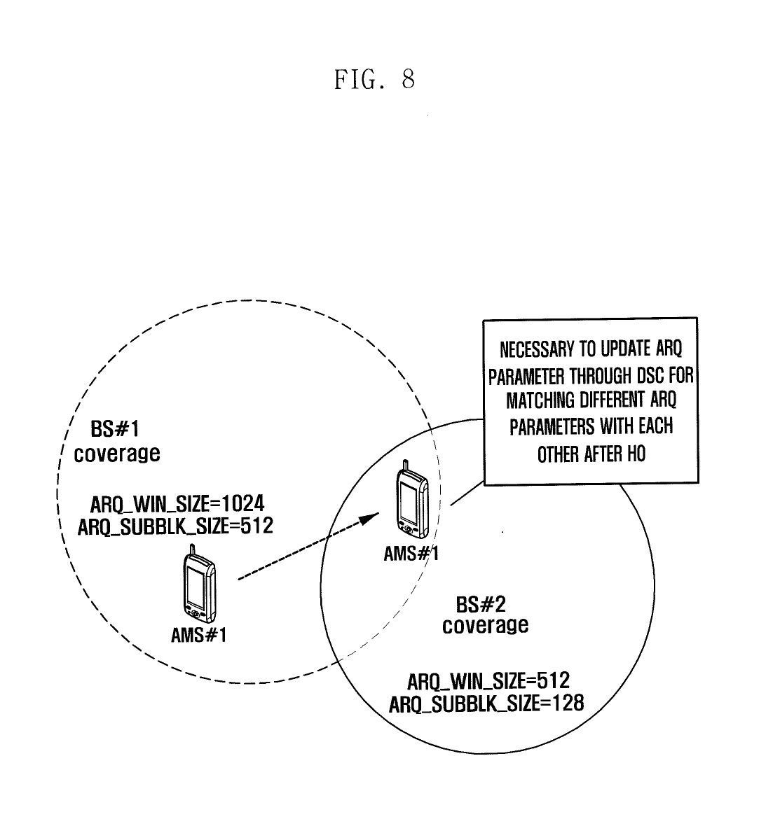

FIG. 8 is diagram illustrating a changing of ARQ parameters due to the handover between base stations operating with different ARQ parameters according to an exemplary embodiment of the present invention. In FIG. 8, it is assumed that the mobile station that has completed a call setup with the base station BS#1 operating with an ARQ WINDOW SIZE of 1024 bits and an ARQ_SUB_BLOCK_SIZE of 512 bits moves to another base station BS#2. Here, it is assumed that the base station BS#2 operates with an ARQ WINDOW SIZE of 512 bits and an ARQ_SUB_BLOCK_SIZE of 128 bits.

Referring to FIG. 8, if the AMS#1 performs a handover from BS#1 to BS#2, the target base station BS#2 is difficult to operate with ARQ parameters of the serving base station BS#1 because the ARQ parameters of the BS#1 exceed the capabilities of the target base station BS#2. In this case, it is preferred for the BS#2 to change the ARQ parameters through a DSC process with the AMS#1 should be reconfigured in order to have the AMS#1 operate with ARQ capabilities of the BS#2 after the completion of the handover. That is, it is necessary to reconfigure the call setup of the AMS#1 with the ARQ_WIN_SIZE being 512 bits and the ARQ_SUBBLK_SIZE being 128 bits, as supported by the BS#2. The ARQ parameters can be defined as shown in Table 2.

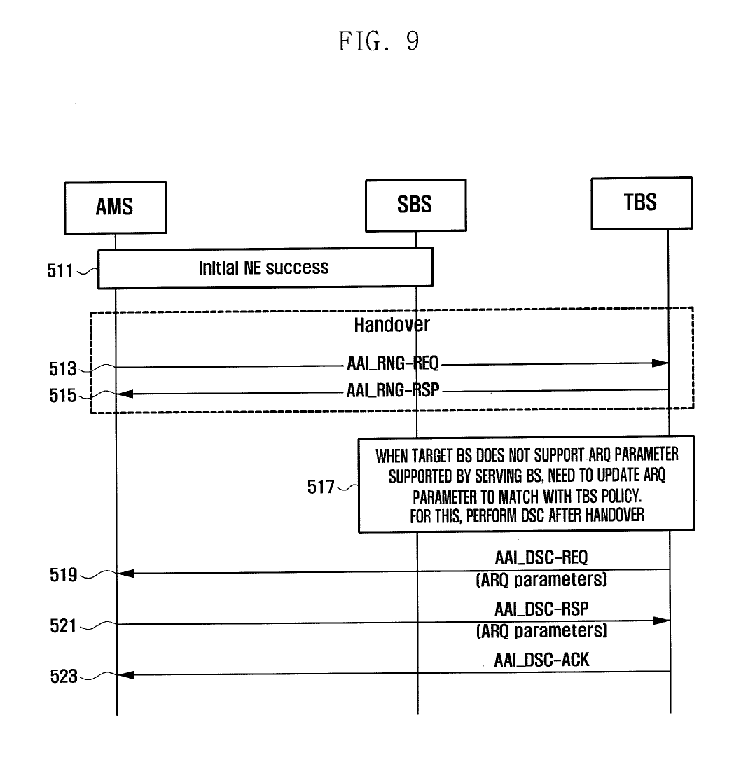

FIG. 9 is a flowchart illustrating a procedure of changing ARQ parameters after completion of a handover in the exemplary situation of FIG. 8 according to an exemplary embodiment of the present invention.

Referring to FIG. 9, the AMS succeeds in completing an initial NE so as to be connected at step 511. Accordingly, step 511 can be the initial NE success state or the state after a new service is added or the state where a service is changed for another through DSA/DSC messaging.

In this state, if the AMS moves from the SBS to the service coverage of the TBS, the AMS and the TBS perform a handover procedure at steps 513 and 515. At this time, the SBS and the TBS can operate with different ARQ parameters as shown in FIG. 8. In such a case where the ARQ parameters provided by the SBS are not supported by the TBS, it is preferred to change the ARQ parameters for the ones supported by the TBS. Accordingly, the SBS and the TBS start an ARQ parameter change procedure through DSC messaging at step 517 after completion of the handover procedure.

In the ARQ parameter change procedure, the TBS generates the AAI_DSC-REQ message including ARQ parameters, such as a changed ARQ_WIN_SIZE and ARQ_SUBBLK_SIZE among the AAI_DSC-REQ/RSP message information of Table 2 according to the policy of the TBS and transmits the AAI_DSC-REQ message to the SBS at step 519. Next, the AMS generates and transmits the AAI_DSC-RSP message to the TBS in response to the AAI_DSC-REQ message at step 521, and the TBS transmits the AAI_DSC-ACK message to the AMS at step 523.

Although it is depicted that the TBS generates and transmits the AAI_DSC-REQ message in FIG. 9, the present invention is not limited thereto, and the AAI_DSC-REQ message can be transmitted from the SBS to the AMS when the DSC is triggered by the SBS. In this case the DSC messages are transmitted in opposite directions compared to the directions shown in FIG. 9.

As described above, the HARQ parameters can be negotiated in AAI_DSA-REQ/RSP messages and AAI_DSC-REQ/RSP messages in the exemplary embodiment of the present invention. Also, an ARQ enable/disable may be negotiated in AAI_DSC-REQ/RSP messages and ARQ-related QoS parameters may be negotiated when ARQ is enabled. The HARQ parameters and ARQ parameters can be defined as shown in Tables 1 and 2. That is, it is possible to add the authorization for HARQ and ARQ parameter changes by modifying the DSA and DSC messages defined in the 802.16m standard as shown in Tables 1 and 2 and, as a consequence, improve the QoS as well as service management efficiency in adaptation to a current and/or changed network environment (such as a VoIP addition, a change of parameters for target base station in handover, a change of ARQ parameters according to an ARQ enable/disable and a strong or weak electric field, and other similar changed network environments).

As described above, the HARQ and ARQ reset method is capable of managing the ARQ and HARQ parameters dynamically in consideration of the network environment or condition. As a consequence, it is possible to improve QoS for the mobile station and provide a service, such as a VoIP service, seamlessly between two base stations having different capabilities.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for controlling a Hybrid Automatic Repeat Request (HARQ) of a mobile communication system, the method comprising:
establishing a default Best Effort (BE) connection;
transmitting, when a Dynamic Service Addition (DSA) is requested for a new service, an Advance Air Interface_DSA-Request (AAI_DSA-REQ) message including HARQ channel mapping information from a base station a mobile station; and
transmitting, when the AAI_DSA-REQ message is received from the base station, an Advance Air Interface_DSA-Response (AAI_DSA-RSP) message from the mobile station to the base station in order to establish a HARQ channel based on the HARQ channel mapping information.

2. The method of claim 1, wherein the new service is a Voice over Internet Protocol (VoIP) service.

3. The method of claim 2, further comprising:
transmitting, when service change is requested, an Advance Air Interface_Dynamic Service Change-Request (AAI_DSC-REQ) message including an HARQ channel mapping rule from the base station to the mobile station;
changing, at the mobile station, the HARQ channel according to the HARQ channel mapping information; and
transmitting an Advance Air Interface_Dynamic Service Change-Response (AAI_DSC-RSP) message from the mobile station to the base station.

4. The method of claim 3, wherein the service change is caused by a change of a serving base station or a change of a VoIP service state.

5. The method of claim 4, wherein the service change is caused by one of a handover of the mobile station and an idle mode exit in which the mobile station transitions from an idle state to an active state.

6. A method for controlling Automatic Repeat Request (ARQ) of a mobile communication system, the method comprising:
maintaining a connection between a mobile station and a base station;
transmitting, when requesting a service which needs an ARQ change, an Advance Air Interface_Dynamic Service Change-Request (AAI_DSC-REQ) message including ARQ parameters of the requested service from the base station to the mobile station; and
transmitting, from the mobile station receiving the AAI_DSC-REQ, an Advance Air Interface_Dynamic Service Change-Response (AAI_DSC-RSP) message to the base station after changing the ARQ parameters.

7. The method of claim 6, wherein the AAI_DSC-REQ message comprises HARQ parameters having an ARQ request for the mobile station that is moving from a strong electric field area to a weak electric field area and ARQ parameters for disabling the ARQ request for the mobile station moving from the weak electric field area to the strong electric field area.

8. The method of claim 6, wherein the AAI_DSC-REQ message comprises ARQ parameters including ARQ enable, ARQ_WIN_SIZE, and ARQ_SUBBLK_SIZE of a target base station when a handover of the mobile station occurs.

9. An apparatus for controlling Hybrid Automatic Repeat Request (HARQ) of a mobile communication system, the apparatus comprising:
a base station for establishing a default Best Effort (BE) connection and transmitting, when a Dynamic Service Addition (DSA) is requested for a new service, an Advance Air Interface_Dynamic Service Addition-Request (AAI_DSA-REQ) message including HARQ channel mapping information from a base station to a mobile station; and
a mobile station for requesting the base station for the new service after establishing the default BE connection, for performing HARQ channel mapping according to the HARQ channel mapping information included in the AAI_DSA-REQ message transmitted by the base station, and for transmitting an Advance Air Interface_Dynamic Service Addition-Response (AAI_DSA-RSP) message to the base station.

10. The apparatus of claim 9, wherein the new service is a Voice over Internet Protocol (VoIP) service.

11. The apparatus of claim 10, further comprising a service change base station which transmits, when the new service is changed to, an Advance Air Interface_Dynamic Service Change-Request (AAI_DSC-REQ) message including a HARQ mapping rule,
wherein the mobile station changes the HARQ channel according to the HARQ channel mapping information and transmits an Advance Air Interface_Dynamic Service Change-Response (AAI_DSC-RSP).

12. The apparatus of claim 11, wherein the service change is caused by a change of a serving base station or a change of a VoIP service state.

13. The apparatus of claim 12, wherein the service change is caused by one of a handover of the mobile station and an idle mode exit in which the mobile station transitions from an idle state to an active state.

14. An apparatus for controlling Automatic Repeat Request (ARQ) of a mobile communication system, the apparatus comprising:
a base station for transmitting, when a service which needs an ARQ change is requested when the base station is in a state connected to a mobile station, an Advance Air Interface_Dynamic Service Change-Request (AAI_DSC-REQ) message including ARQ parameters of the requested service from the base station to the mobile station; and
a mobile station for changing, when the AAI_DSC-REQ is received by the mobile station, the ARQ parameters and for transmitting an Advance Air Interface_Dynamic Service Change-Response (AAI_DSC-RSP) message to the base station.

15. The apparatus of claim 14, wherein the AAI_DSC-REQ message comprises HARQ parameters having an ARQ request for the mobile station moving from a strong electric field area to a weak electric field area and ARQ parameters for disabling the ARQ request for the mobile station moving from the weak electric field area to the strong electric field area.

16. The apparatus of claim 14, wherein the AAI_DSC-REQ message comprises ARQ parameters including ARQ enable, ARQ_WIN_SIZE, and ARQ_SUBBLK_SIZE of a target base station when a handover of the mobile station occurs.
